(19) United States
(12) Patent Application Publication
(10) Pub. No.: US 2020/0242977 A1
(43) Pub. Date: Jul. 30, 2020

(54) Food Quality Certification Code

(71) Applicant: Bassam T. Al-Nemri, Hopewell Junction, NY (US)

(72) Inventor: Bassam T. Al-Nemri, Hopewell Junction, NY (US)

(21) Appl. No.: 15/959,221

(22) Filed: Jul. 19, 2018

(51) Int. Cl. G09F 3/02; B65D 5/42

(52) U.S. Cl. CPC G09F 3/02; B65D 2203/02; G09F 2003/0272; B65D 5/4212

(57) ABSTRACT

The Food Quality Classification System is the first in the United States, and the world, to combine ingredients, manufacturing processes, economic and marketing factors in its food quality valuations. Our “classification code” draws upon innovative methodologies in order to assess the quality of food items. This process is informed by comprehensive parameters that are internationally defined and accepted. All food is assessed and assigned a unique classification code that represents the total quality of that product: ingredients, freshness, manufacturing processes, marketing strategies and cost. This classification code enables consumers to distinguish the quality of foods in the market, which will help them make decisions on products with equal classifications based on quality and price. The classification code is highly recognizable and accessible to consumers due to its legibility on food packages. It can be used not only for raw and processed foods, but also for food production and animal feed as well.

The following is a simple nutritive scenario for a new Classification Method for the essential Food items.

The Purpose is just to establish a simple method to classify food items according to their ingredient types, and the overall processes to produce such product. These Steps will include the production, packaging, preserving, and storage types that is being used to produce the food product in its final shape.

This method of food quality classification will be determined according to the international definitions of Organic, Natural, Non-GMO, Processed food, and any other General Good Manufacturing Practices that affect the final food product and its Purity, Safety, and sustainability.

The Final Classification Result will be as A Code; Easy to Read on the food product package, and Easy to be interpreted into useful knowledge.

The Classification Code is a Scale that will consist of Three Characters:
1—The First Character is a Capital Latin Letter that could be one of the following: A, B, C, D, E, F, the total of six Latin Letters.
2—The Second Character is a small case Latin Letter that could be one of the following: a, b, c, d, the total of four Latin Letters.
3—The Third Character is an Arabic Number that could be one of the following numbers:
   The Numbers; 1, 2, 3, 4, 5, 6, 7, 8, 9, 10
   The First Character is mostly related to the ingredients.
   The Second Character is mostly related to the Processing, Preparations, Preserving, and Packing of the Wholesome Product.

The Third Character will include the Processing, and the Nature of The Ingredients, and Extend to the Current Market Portfolio and History of the product in the market.

It will include the additional nutritional and Preferred Values for the customers.

The top best Classification Mark will be recognized by having the Code: (Aa10).

In the other side, The Lowest Classification Mark will be as low as (Fd1). Each Type of Food will be assessed among similar products in that food production industry, considering all the good manufacturing practices of that specific industry. Focusing on what makes a good product, maintaining safety, purity, and nourishment with wholesome added values.

For example: All Sliced Bread will be under the same kind of research and study, analyzed and compared to be classified under one scale and ethical classification process.

The end-product will be A fair Classification Code that will determine all the measured values input in the food product. The Classification code given to a product will benefit the consumer; it will also declare easily the value for the good products in the market place.

The Parameter elements that will be used in the Classification process will include all, or some of the following:
A—Food preparation methods.
B— According to the label, all valid information and direction.
C— Source of Ingredients; home, local, Seasonal, or imported from international markets.
D—The Species of the fish, or animal; like the Alaskan salmon, wild or farm raised, or GMO, etc.
E—Part of the food used; leg, or thy meat. Fruit oil, or leaf oil etc.
F— Package Type, durability, flexibility and appearance.
G—Production methods; Organic, Grain, or Grass Fed. Free Range etc.
H— For Beverages; Consumed as prepared, or Diluted with water or milk etc.
I— Sugar Contents, Honey. Sweetened, and what kind of sweetener used.
J—Fat contents, and what kind of fats, or oils used; and trans-fat contents.
K— Added chemical or biological agents, and modified ingredients used.
L—Information from National and International Data Base for Agriculture and Farms, and Fisheries.
M—Markets, and Consumers Data-Institutions, like schools and colleges, Hospitals, Nursing Homes, and caterers.
N— Ongoing Good Industrial, and Technological Methods of Production.
O—GSI, and GP Controls and up to date, Quality Control and Quality Assurance.
P— Food Balance Sheet Data.
Q—The Information on the Food Packaging, Transparency, and Data Verification.
R— Brand Name and Prestige, and Market Research and Economical Data.

Purpose:
1. To provide a food classification system that offers a distinct set of standardized valuations of food quality.
2. To declare a ranked value for food products that is easily understood and recognizable.
3. Economic? To better compare the total quality for a product and the price value in the marketplace.

The invention is a new classification method for food products.

The pieces and parts of this invention are:

1. A code that consist of Latin letters and numbers.

2. Parameters elements used in the classification presses (mentioned earlier in the specifications from A-R) in the introduction.

3. Code Table included in the specifications, is used as reference to compare with.

Applying the parameters into a particular food product will determine specification that lead to a Classification Code.

This code will be loaded with a reference code Table to compare and classify.

CODE TABLE

| | a | b | c | d |
|---|---|---|---|---|
| A | Aa | Ab | Ac | Ad |
| B | Ba | Bb | Bc | Bd |
| C | Ca | Cb | Cc | Cd |
| D | Da | Db | Dc | Dd |
| E | Ea | Eb | Ec | Ed |
| F | Fa | Fb | Fc | Fd |

Capital Letters:
A. Organic, no hormones, no antibiotics, no added sugar or sweeteners, color Enhancers or artificial fixers, and none GMO.
B. Natural with all the above Description in A without the condition of certified organic but must be certified natural, no additives and preservatives.
C. All the above and cannot have hormones or antibiotics, with minimum additives and artificial flavors.
D. Includes preservative or artificial additives and flavors, and sugar added.
E. All in D above but strictly none GMO, and no denaturing of ingredients.
F. No restrictions on GMO ingredients

Small Letters:
a. None processed ingredients.
b. Minimum processing.
c. Moderately processed.
d. Consist of moderately processed ingredients, multi processed with denatured ingredients.

The third character numbers can be categorized as the top of the best.

Between Aa1 to Aa10: where Aa1 is the lowest and Aa10 is highest.

Any point gained by using a better possessing method to produce a product, will rise over all classification into a better level.

The highest (best) classification code product will be in the upper left square of the code table, and the lowest will be in the bottom right of the code table.

1. Our food quality classification system offers ethical parameters to determine the total quality of food products.

2. Each food Product will score its unique classification code according to its ingredients, processing methods, preservation and final packing shape and form.

3. The classification code for a food product will be easily interpreted and understood in reference to a Table scale (Table Code) added with the specifications.
